(19) United States
(12) Patent Application Publication
(10) Pub. No.: US 2013/0246238 A1
(43) Pub. Date: Sep. 19, 2013

(54) Investment Portfolio Exchange System and Method

(71) Applicants: Zhe Chen, Toronto (CA); Lijing Liu, Toronto (CA)

(72) Inventors: Zhe Chen, Toronto (CA); Lijing Liu, Toronto (CA)

(21) Appl. No.: 13/424,330

(22) Filed: Mar. 19, 2012

(51) Int. Cl. G06Q 40/04

(52) U.S. Cl. 705/37

(57) ABSTRACT

The present invention discloses a method, and apparatus for a computer-implemented financial investment system that permits investors to exchange their portfolios and trading activities of the portfolios via Internet. A registered user's portfolio contains financial products and trading activities of the financial products. A user can publish his/her portfolio and the portfolio's trading activities. A user can view other user's portfolios and the trading activities of the portfolios. The platform facilitates trading portfolio and trading idea exchanges among registered users.

### BACKGROUND OF THE INVENTION

1. Field of the Invention

The invention relates generally to an online system for investors to exchange their portfolios and trading activities of their portfolios containing financial products. A registered user can publish his/her trading portfolios and the portfolio's trading activities. And a registered user can view other users' portfolios and the trading activities of the portfolios.

2. Description of Related Art

In today's financial market, what is so important for investors is how to get investment advices. The information can be found from market commentators, financial analysts, brokers, newsletter publishers, trading authors, etc, in magazine articles, on television, even in SPAM. As Internet is getting popular, investors also access information from financial websites, discussion board, stock forum, and chatting room.

Recently, powered by the Internet and the concept of web 2.0, “Social Investing” has picked up investors' interest. “Social investing” is loosely defined as services that add a social network twist to online financial and investing information. These online communities help subscribers share, track, and rank recommendations on stock picks and other investments.

All those advices and recommendations focus on what stocks are performing great, and what should be in your portfolio. One issue of this is that the performances only reflect the past, not the future. A stock performed greatly in the past won't guarantee it will continue performing the same way in the future. The other issue is that the market is up and down every day, even a great stock could be down for a certain time frame. To maintain the performance of a portfolio, investors want to know not only what to sell and what to buy, but when to trade.

Thus, there is a need from investors that they want to exchange their ideas about not only what to buy and sell, but when. Investors want to know, when providing a portfolio with good performance, the trading activities of the portfolio. And more important, investors want to know the trading activities immediately when there is new trading activity in the portfolio.

### SUMMARY OF THE INVENTION

To overcome the limitations in the prior art described above, the present invention discloses method, apparatus of implementation for an online system that permits investors to exchange their portfolios and the trading activities of the portfolios.

In accordance with the present invention, a server computer(s) hosts a web site on which investors can create portfolio(s), record trading activities of each of the portfolios.

An object of the present invention is to allow users to publish their portfolio(s) and the trading activities of their portfolio(s).

An object of the present invention is to allow user to view the other's portfolios and all the trading activities in those portfolio(s). And the viewed portfolio(s) is recorded in this user's view history list.

An object of the present invention is that once a portfolio owner updates any of his portfolios, the platform will notify all the users having this portfolio on their view history list.

### BRIEF DESCRIPTION OF THE DRAWINGS

The invention is described in detail herein with reference to the drawings in which:

FIG. 1 is a block diagram of an exemplary hardware environment of the present invention;

FIG. 2 is a sample home page of a web site that implements the investment portfolio exchange system according to an embodiment of the invention;

FIG. 3 is a sample registration page of the web site;

FIG. 4 is a sample login page of the web site;

FIG. 5 is a sample page to list all the portfolios in a registered user's account;

FIG. 6 is a sample page to show the portfolio details, after a registered user clicks on one of the portfolios from his/her portfolio list;

FIG. 7 is a sample page to show the user all the trading activities of the portfolio selected from his/her portfolio list;

FIG. 8 is a sample page to show the user the message board of the portfolio selected from his/her portfolio list;

FIG. 9 is a sample page to allow the user to post message to the message board of the portfolio selected from his/her portfolio list;

FIG. 10 is a sample page to allow user to create a new portfolio in his/her account;

FIG. 11 is a sample page to allow user to search portfolio in the system;

FIG. 12 is a sample page to list the view history of the current user;

FIG. 13 is a sample page to show the details of the portfolio, after a user clicks on one of the portfolios from his/her view history list;

FIG. 14 is a sample page to show the trading activities of the portfolio selected from the view history list;

FIG. 15 is a sample page to show the message board of the portfolio selected from the view history list;

FIG. 16 is a sample page to allow user to post message to the message board of the portfolio selected from the view history list;

The accompanying drawings, which are incorporated in and constitute a part of the specification, illustrate presently preferred exemplary embodiments of the invention, and, together with the general description given above and the detailed description of the preferred embodiments given below, serve to explain the principles of the invention.

### DETAILED DESCRIPTION OF THE PREFERRED EMBODIMENTS

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

1. Overview

The present invention comprises a computer-implemented online system for investors to record and exchange their portfolios and the trading activities of the portfolios. The present invention allows investors to create portfolios, record the trading activities, and post messages. The present invention allows each investor to view other investors' portfolios and the trading activities of the portfolios, and post messages to the message boards of the portfolios. One preferred embodiment of the present invention is a computer-implemented web site, which may be implemented as a simulation (i.e. paper-trading platform) or as an actual platform for investors to record and exchange their portfolios, trading activities, and trading ideas.

2. Hardware Environment

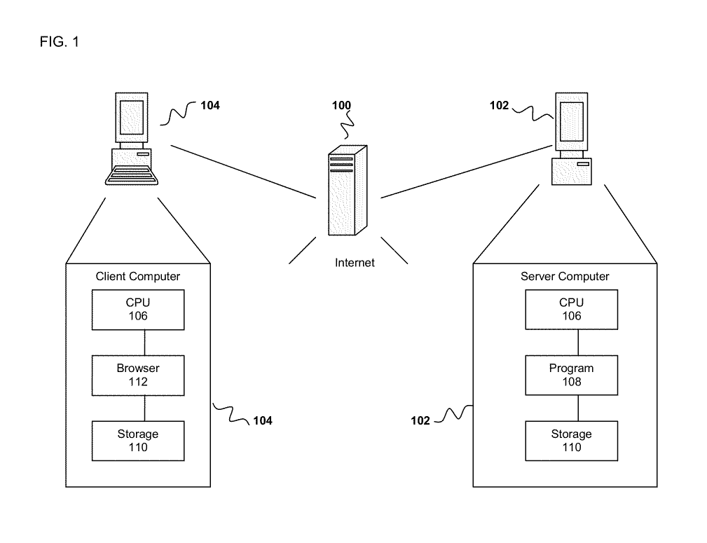

The portfolio exchange web site according to an embodiment of the invention is illustrated in FIG. 1, which presents a typical distributed computer system using the Internet 100 to connect client computers 104 executing for example, Web browsers 112, to connect to server computers 102 executing a computer program 108 embodying the present invention.

A typical combination of resources may include client computers 104 that are personal computers or work stations connected via the Internet 100 to server computers 102 that are personal computers, work stations, minicomputers, or mainframes.

Generally, both the client computers 104 and the server computers 102 are comprised of one or more CPUs 106, various amounts of RAM storing computer programs and other data, and other components typically found in computers. In addition, both the client computers 104 and the server computers 102 may include one or more monitors, and fixed or removable data storage devices 110 such as hard disk drives, floppy disk drives, and/or CD-ROM drives. Also included may be input devices such as mouse pointing devices and keyboards. Both the client computers 104 and the server computers 102 operate under the control of an operating system, such as Windows, Macintosh, UNIX, etc.

Further, the client computers 104 executes browser program 112 under its operating system. The interface between the user and the server computer is a browser, e.g., Netscape Navigator or Internet Explorer, which is executed on the client's computer.

Generally, the server computers 102 each execute one or more computer programs 108 under the control of it respective operating systems. The present invention is preferably implemented as one or more computer programs 108, embodying, the present invention, executed by the server computer 102. The computer programs 108 implementing the present invention are embodied in a computer-readable medium, e.g. one or more of the fixed and/or removable data storage devices 110 attached to the computer. Under control of the operating system, the computer programs 108 may be loaded from the data storage devices 110 into the RAM of the computer for subsequent execution by the CPU 106. The computer programs 108 comprise instructions which, when read and executed by the computer, cause the computer to perform the steps necessary to execute the steps or elements of the present invention.

Those skilled in the art will recognize that the exemplary environment illustrated in FIG. 1 is not intended to limit the present invention. Indeed, those skilled in the art will recognize that other alternative hardware environments may be used without departing from the scope of the present invention.

3. Web Site Detail Description

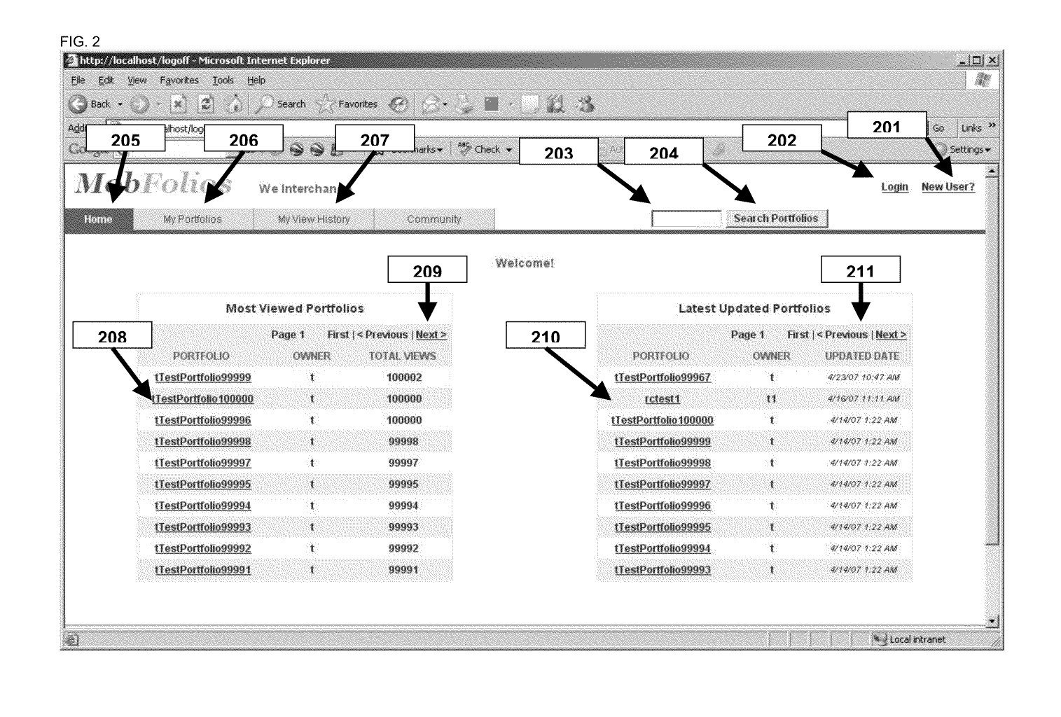

FIG. 2 is a sample home page that is displayed to a user who accesses the web site. The user accesses this home page by typing in its URL (Uniform Resource Locator), e.g., “www.mobfolios.com,” into the browser.

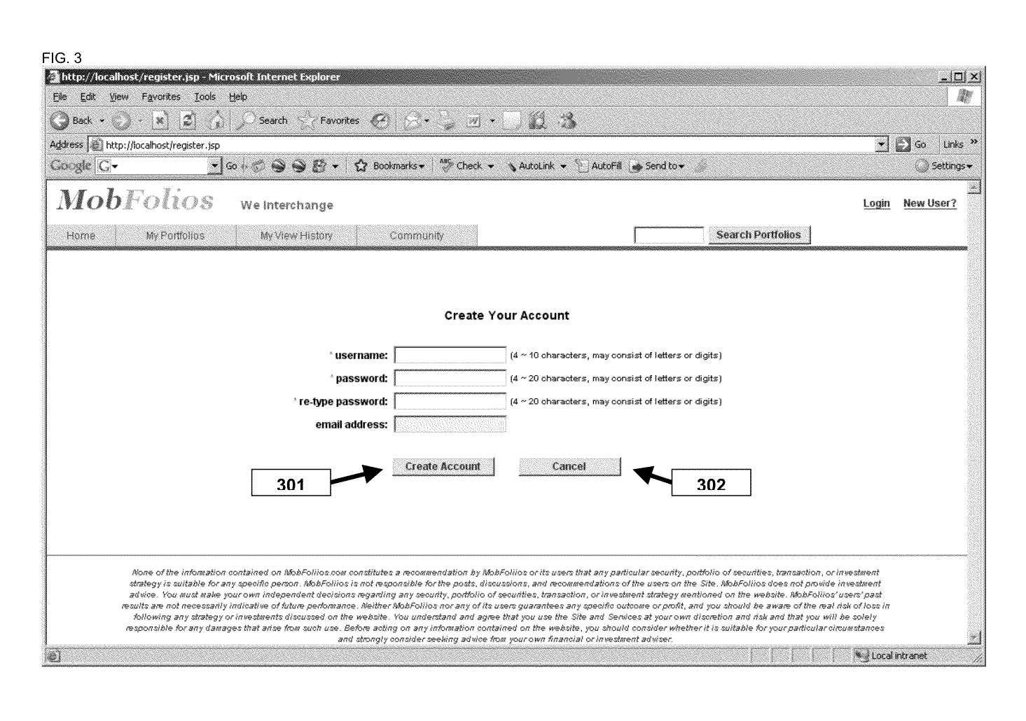

The home page provides a hyperlink 201. If the hyperlink 201 is selected, a registration web-page shown in FIG. 3 is displayed to the user.

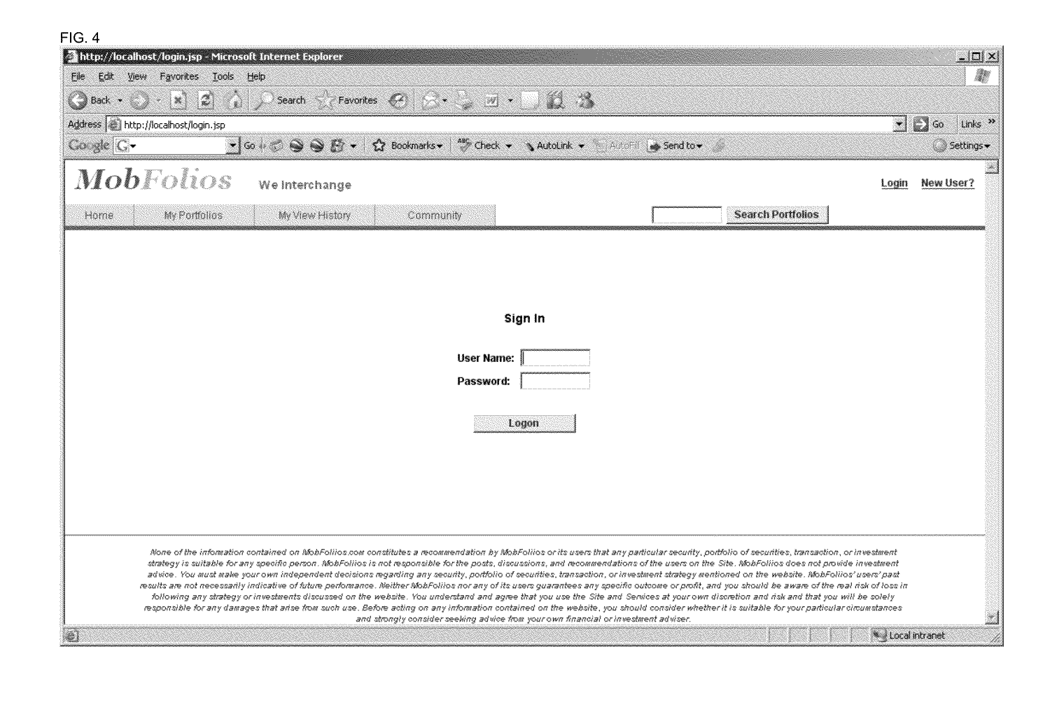

The home page provides a hyperlink 202. If the hyperlink 202 is selected, a login web page shown in FIG. 4 is displayed to the user and the user is prompted to enter username and password to log onto the system.

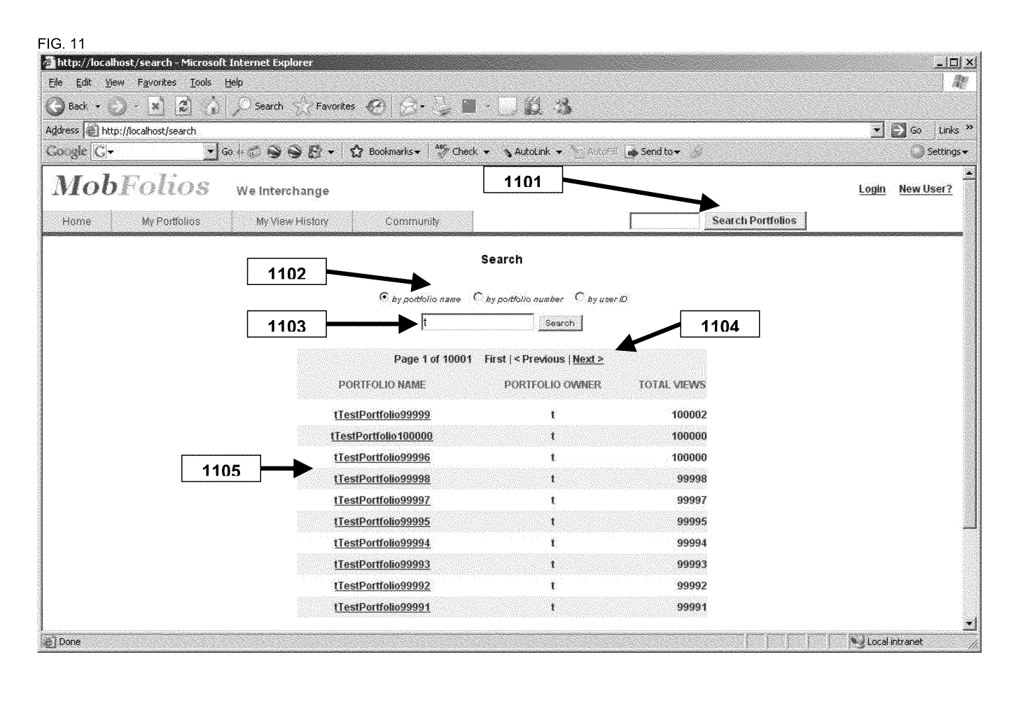

The home page also provides a text box 203 and button 204. User can enter search criteria into text box 203 and click button 204 to perform portfolio search. Once the button 204 is clicked, the search result is displayed on a search page as shown in FIG. 11.

The home page also provides a tab 205 which contains a hyperlink. If the tab 205 is clicked, this home page will be displayed to the user.

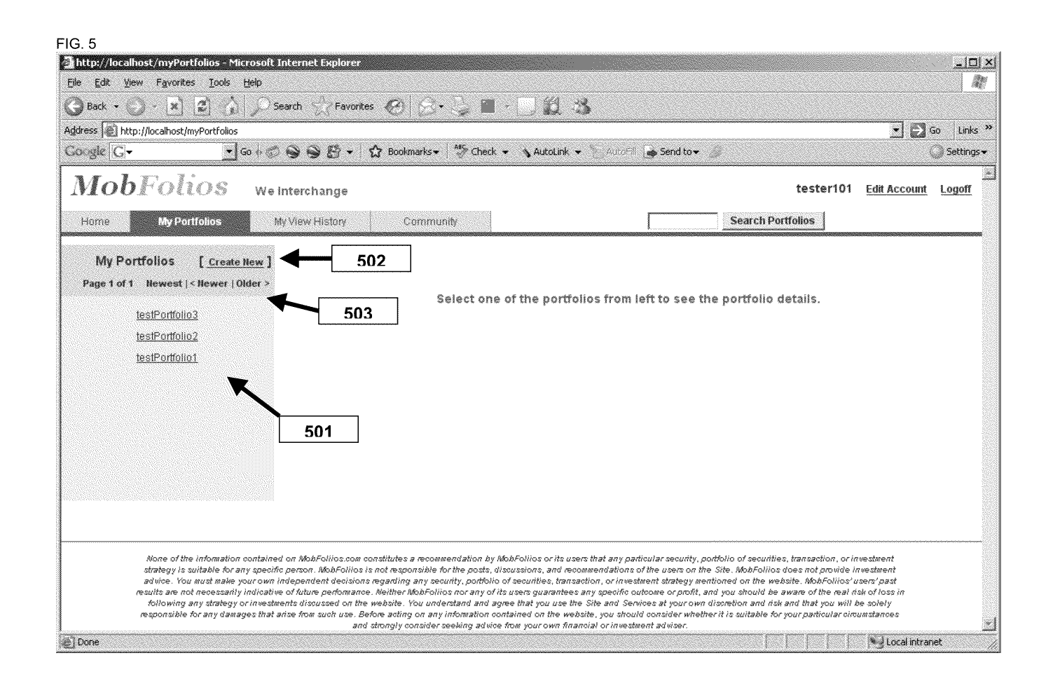

The home page also provides a tab 206 which contains a hyperlink. If the tab 206 is clicked, a portfolio web page, which lists all the portfolio of the current user as shown in FIG. 5, is displayed to the user.

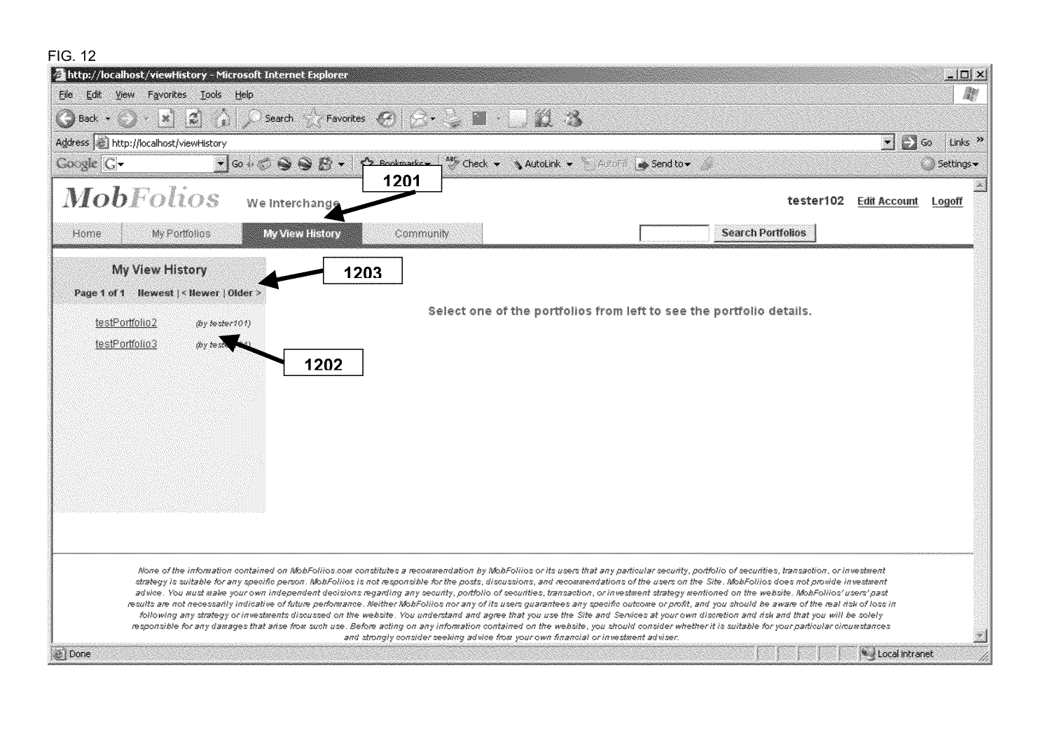

The home page also provides a tab 207 which contains a hyperlink. If the tab 207 is clicked, a view history web page, which lists all the portfolios the current user has viewed, as shown in FIG. 12, is displayed to the user.

The text box 203, button 204, and tab 205, 206, 207 are shown on all the pages of the web site, to allow user to navigate among different page easily.

When tab 206 or 207 is selected, if user has not logged in the system, the login page will be displayed to the user to prompt the user to login.

The home page also provides a list of all the portfolios in the system, as shown in section 208. The list in section 208 is ordered by view count of the portfolios. User can select any one of the portfolios in the list to view the details of the selected portfolio. A navigation bar is provided, as shown in section 209, to allow user to navigate the list page by page.

The home page also provides another list of all the portfolios in the system, as shown in section 210. The list in section 210 is ordered by last updated date and time of the portfolios. User can select any one of the portfolios in the list to view the details of the selected portfolio. A navigation bar is also provided, as shown in section 211, to allow user to navigate the list page by page.

FIG. 3 is a sample registration web page to allow user to register an account. User is prompted to provide a user name, password and email address. After user clicks the ‘Create Account’ button 301, the system will create an account for the user. User can cancel the registration process by clicking the cancel button 302.

FIG. 4 is a sample login web page to prompt user to log into the system by entering his or her username and password. After entering username and password, user clicks the ‘Logon’ button to log onto the system.

FIG. 5 is a sample ‘My Portfolios’ web page displayed to a user to show the user all the portfolios in his/her account. This web page is displayed when the user logs into the system, or when the user clicks on the ‘My Portfolio’ tab at anytime after the user has logged into the system.

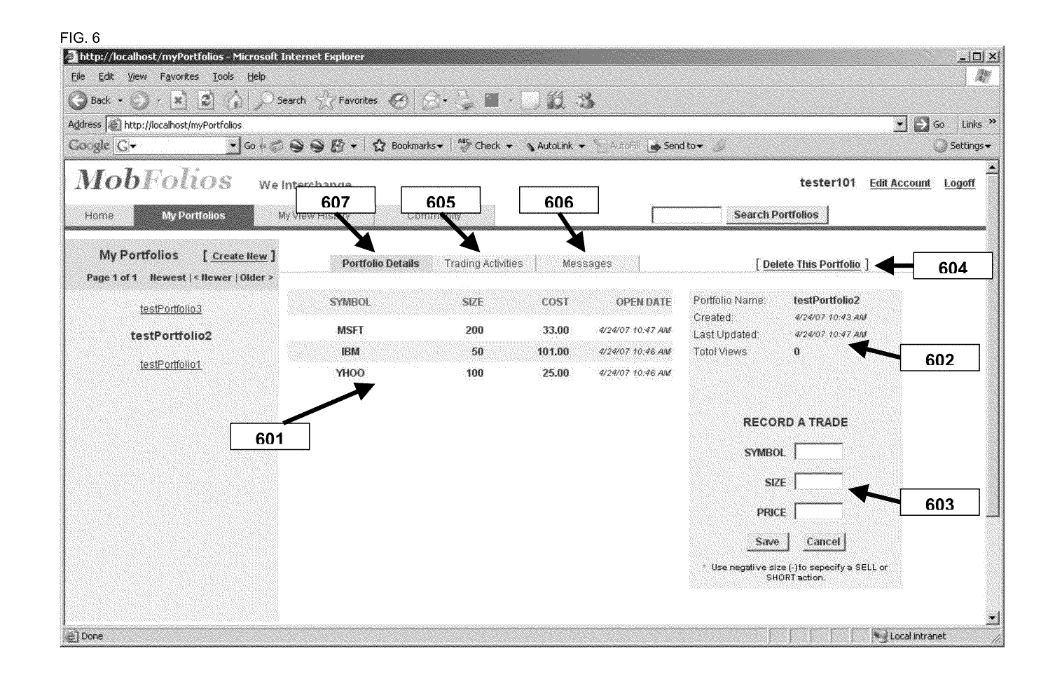

On ‘My Portfolios’ web page, section 501 lists all the portfolios that the user has created in his/her account. System maintains a portfolio list for each account. User can click any of the portfolios from the portfolio list in section 501 to view the portfolio details of the selected portfolio. Once the user selects one of the portfolios from portfolio list 501, a portfolio details web page as shown on FIG. 6 is displayed to show the details of the selected portfolio.

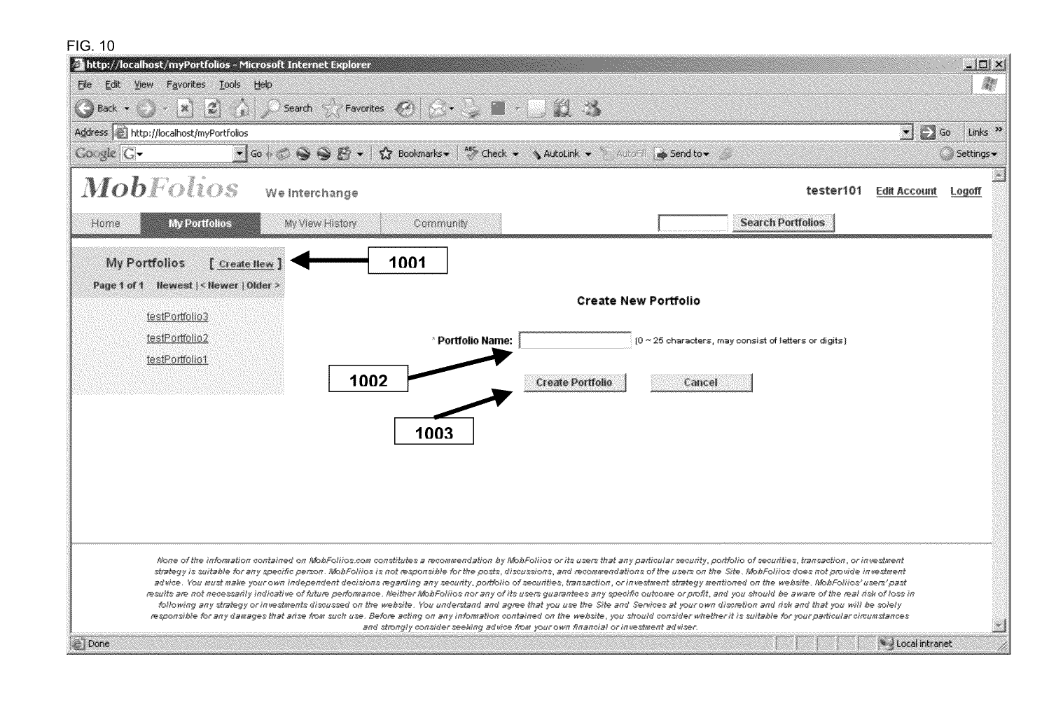

On ‘My Portfolios’ web page, user can click the ‘Create New’ hyperlink 502 to create a new portfolio in his/her account. Once the user clicks the hyperlink 502, a new portfolio web page as shown on FIG. 10 is displayed to allow user to create a new portfolio.

On ‘My Portfolios’ web page, a navigation bar, as shown in section 503, is provided to allow user to navigate his/her portfolio list page by page.

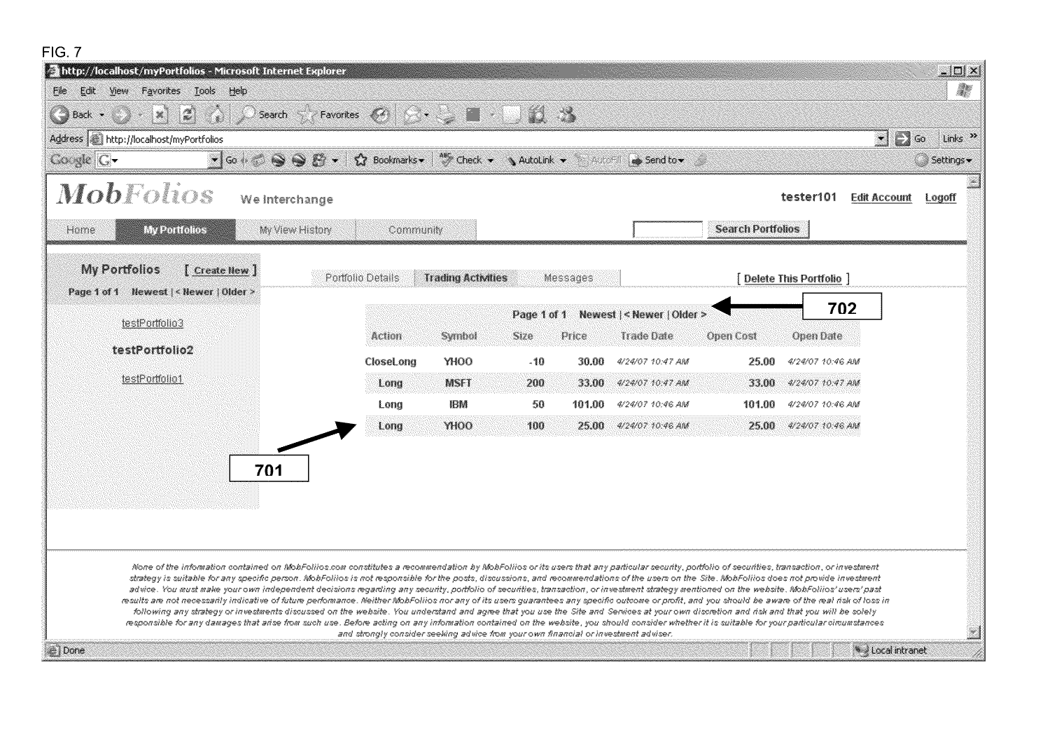

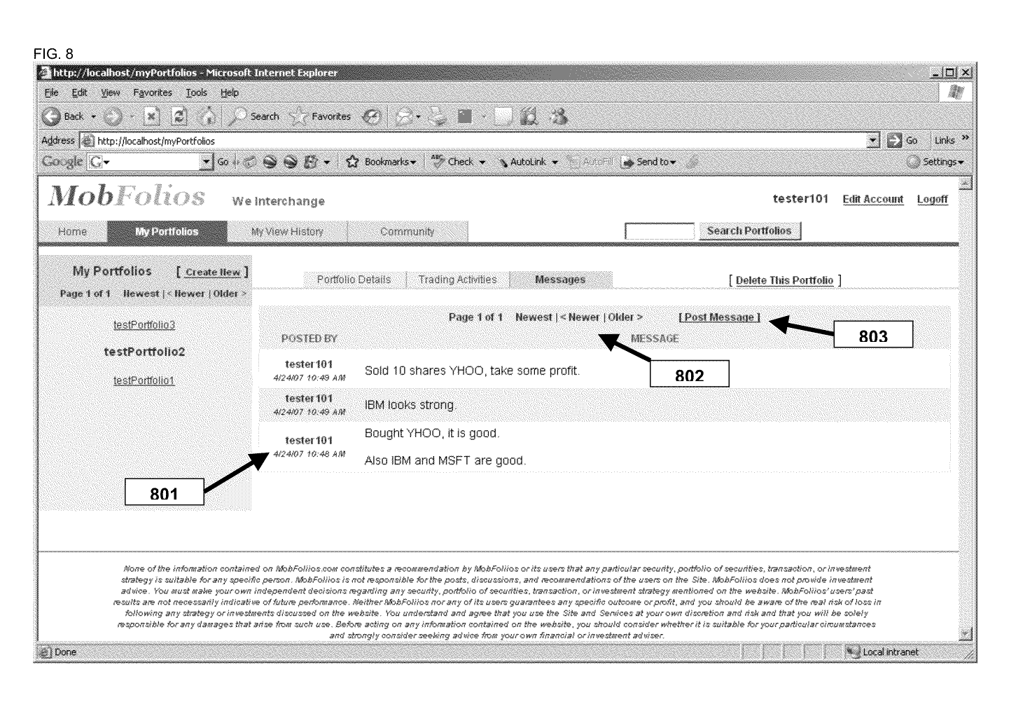

FIG. 6 is a sample portfolio details web page to show the user the details of the portfolio, after user selects one of the portfolios from the portfolio list. For the selected portfolio, tab 605, 606, 607 are provided to allow user to view the different aspects of this selected portfolio. Tab 605 contains a hyperlink to the portfolio trading activity page, as shown on FIG. 7, which list all the trading activities of the portfolio. Tab 606 contains a hyperlink to the message board page, as shown on FIG. 8. Tab 607 contains a hyperlink to the portfolio details page, as shown on FIG. 6.

On the portfolio details web page as shown on FIG. 6, section 601 lists all the holdings of the portfolio. System maintains a holding list for each portfolio. Section 602 shows the creation date, last updated date and view count of the portfolio.

On the portfolio details web page as shown on FIG. 6, section 603 allow user to record a trading or a transaction into the portfolio. After user enters the symbol, size, price, and clicks ‘Save’ button, the new trading record will be recorded into the portfolio. The page will be refreshed to display the new trading record in the holding list, as shown in section 601.

On the portfolio details web page as shown on FIG. 6, user can delete the portfolio by clicking the button 604. After the button 604 is clicked, the portfolio is removed from system. The page will be refreshed and the deleted portfolio will not be shown on the portfolio list.

FIG. 7 is a sample trading activity web page to show the user the trading activities of the selected portfolio. System maintains a trading activity list for each portfolio. Once user records a trading on the portfolio details page as shown on FIG. 6, the trading activity will be listed on section 701.

On the trading activity web page as shown on FIG. 7, a navigation bar, as shown on section 702, is provided to allow user to navigate the trading activities page by page.

FIG. 8 is a sample message board web page for the selected portfolio. System provides a message board for each portfolio. Section 801 list all the messages posted by the portfolio owner, or messages posted by the portfolio viewers.

On the message board web page as shown on FIG. 8, a navigation bar, as shown on section 802, is provided to allow user to navigate the messages page by page.

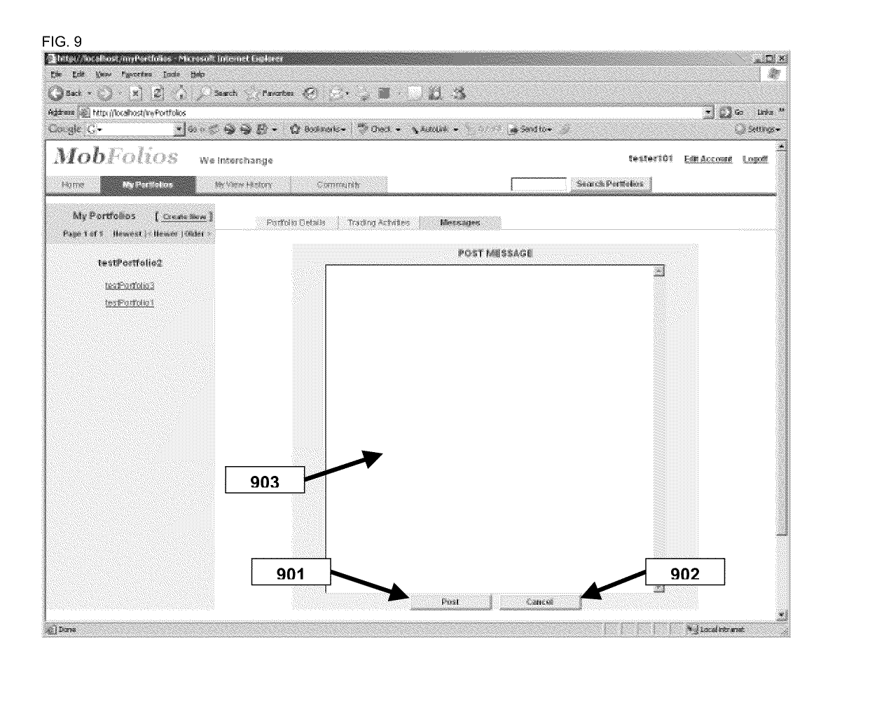

On the message board web page as shown on FIG. 8, a hyperlink 803 is provided to allow user to post new message to the message board. Once user clicks the hyperlink 803, a message posting web page, as shown on FIG. 9, is displayed to allow the user to post a new message.

FIG. 9 is a sample message posting web page. User enters message text into text area 903, and clicks ‘Post’ button 901 to post a new message. Once user clicks the ‘Post’ button, the message is posted onto the message board of the selected portfolio, and system navigates to the message board page, as shown on FIG. 8. The new message is displayed on the message board.

If user clicks ‘Cancel’ button 902, system navigates back to the message board page, as shown on FIG. 8, with no message posted onto the message board.

FIG. 10 is a sample page to allow user to create a new portfolio in his/her account. This page is displayed once user clicks the ‘Create New’ hyperlink 1001. After user enters portfolio name into text box 1002, and clicks ‘Create Portfolio’ button 1003, a new portfolio is created and listed on the portfolio list.

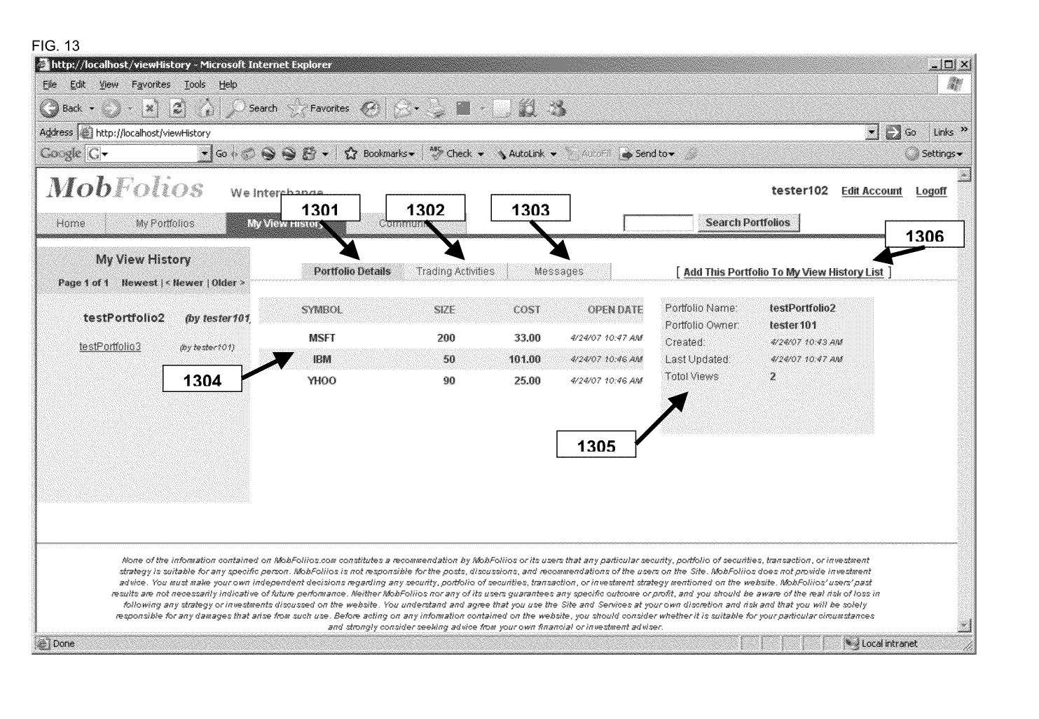

FIG. 11 is a sample search web page, to allow user to search portfolios in the system. This page is displayed once user clicks the ‘Search Portfolio’ button 1101. User can search portfolio according to portfolio name, portfolio number, or portfolio owner's ID by selecting search type in section 1102. After user enter searching criteria in text box 1103, and clicks ‘Search’ button, the searching result is listed in section 1105. A navigation bar 1104 is provided to allow user to navigate the searching result page by page. User can click any of the portfolios in section 1105 to view the details of the portfolio. Once user clicks on any of the portfolios, the details of the selected portfolio will be display on the page as shown in FIG. 13.

FIG. 12 is a sample web page to show the view history list of the current user. System maintains a view history list for each account. The view history list contains the portfolios, which are owned by other users, this user has viewed. When the user access a portfolio owned by the other user, he/she can decide whether or not to add the portfolio into he/her view history list.

User navigates to this page by clicking ‘My View History’ tab 1201. On the left panel of this page, section 1202 is the view history list that lists the portfolios that this user has viewed and added to the view history list. A navigation bar 1203 is provided to allow user to navigate the list page by page.

User can click one of the portfolios in the view history list to view the portfolio details as shown in FIG. 13.

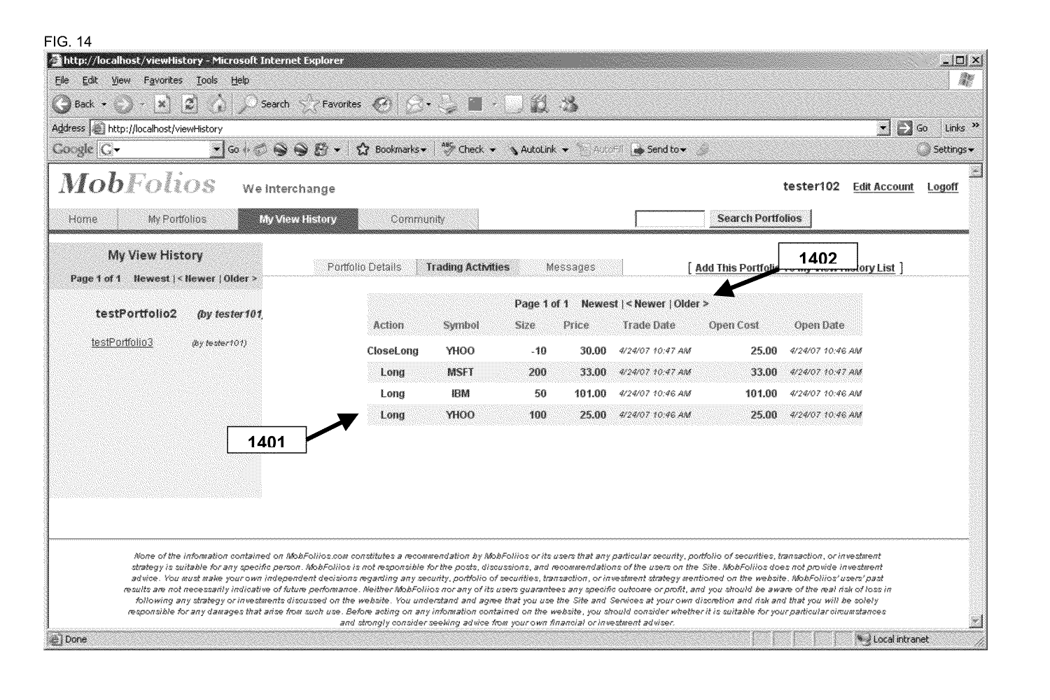

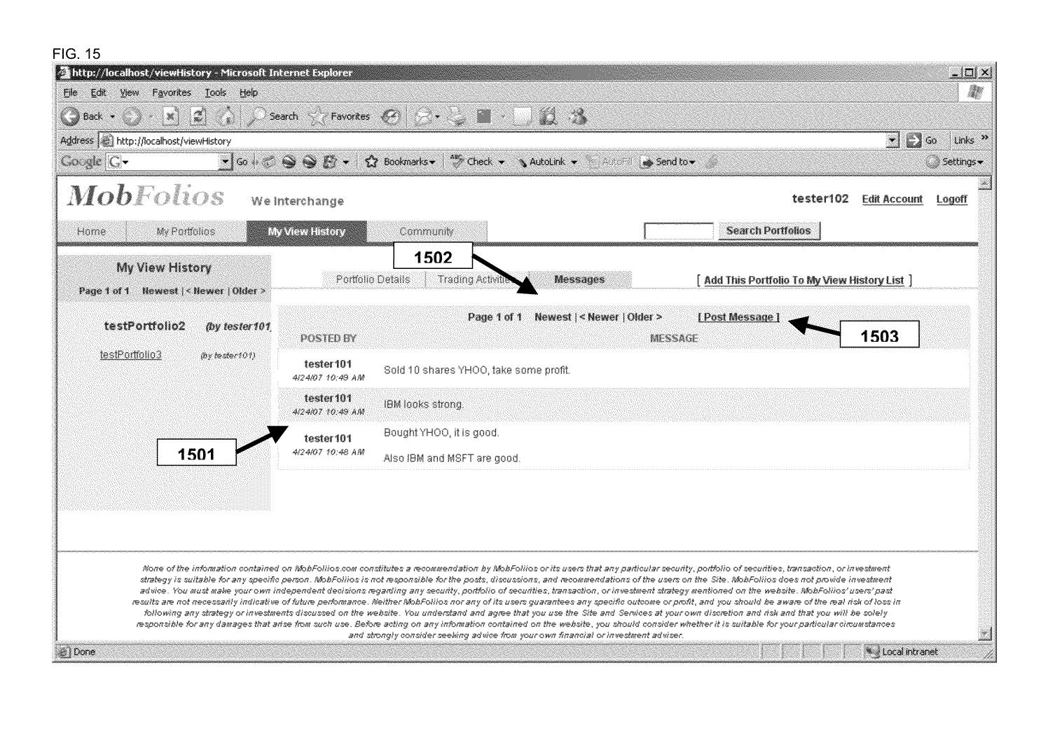

FIG. 13 is a sample portfolio details web page to show the user the portfolio details, after user selects one of the portfolios from the view history list, or from search result list. For the selected portfolio, tab 1301, 1302, 1303 are provided to allow user to view the different aspects of this selected portfolio. Tab 1302 contains a hyperlink to the portfolio trading activity page, as shown on FIG. 14, which list all the trading activities of the portfolio. Tab 1303 contains a hyperlink to the message board page for the portfolio, as shown on FIG. 15. Tab 607 contains a hyperlink to the portfolio details page, as shown on FIG. 13.

On the portfolio details web page as shown on FIG. 13, section 1304 lists all the holdings of the portfolio. Section 1305 shows the creation date, last updated date and view count of the portfolio.

On the portfolio details web page as shown on FIG. 13, if user navigates to this page by selecting a portfolio from the search result list, and the selected portfolio is not in the user's view history list, a hyperlink 1306 is provided to allow user to add the portfolio into his/her view history list. After user clicks the hyperlink 1306, the page will be refreshed and the portfolio will be listed on the view history list on the left panel of the page.

FIG. 14 is a sample trading activity web page to show the user the trading activities of the portfolio selected from the view history list, or selected from the search result list. The trading activities of the selected portfolio are listed on section 1401.

On the trading activity web page as shown on FIG. 14, a navigation bar, as shown on section 1402, is provided to allow user to navigate the trading activities page by page.

FIG. 15 is a sample message board web page for the portfolio selected from the view history list, or selected from the search result list. Section 1501 list all the messages posted by the portfolio owner, or messages posted by the portfolio viewers.

On the message board web page as shown on FIG. 15, a navigation bar, as shown on section 1502, is provided to allow user to navigate the messages page by page.

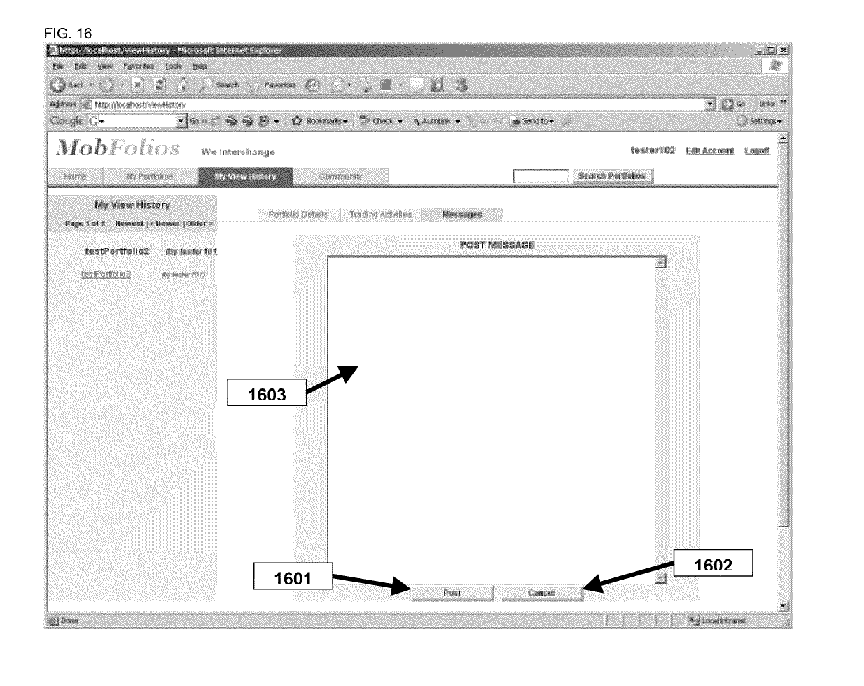

On the message board web page as shown on FIG. 15, a hyperlink 1503 is provided to allow user to post new message to the message board. Once user clicks the hyperlink 1503, a message posting web page, as shown on FIG. 16, is displayed to allow the user to post a new message.

FIG. 16 is a sample message posting web page. User enters message text into text area 1603, and clicks ‘Post’ button 1601 to post a new message. Once user clicks the ‘Post’ button, the message is posted onto the message board of the selected portfolio, and system navigates to the message board page, as shown on FIG. 15. The new message is displayed on the message board.

If user clicks ‘Cancel’ button 1502, system navigates back to the message board page, with no message posted onto the message board.

What is claimed is:

1. An computer and Internet implemented method to implement an online system for investors to publish and exchange trading activities of their portfolios containing financial products, comprising:
a) Receiving registration from investors, and creating accounts for investors;
b) Allowing a registered user to create one or multiple portfolios in his/her account; Also maintaining a portfolio list for each account;
c) Maintaining the transaction and trading activity list for each portfolio;
d) Allowing a registered user to record transactions and trading activities into any one of his/her portfolios;
e) For each portfolio, maintaining a holding list containing all the holdings of the portfolio, based on the transaction and trading activities recorded into this portfolio by the portfolio owner;
f) Maintaining a message board for each portfolio;
g) For each portfolio, publishing the transaction and trading activity list, the portfolio holding list, and the message board to other users;
h) Allowing a registered user to view the holding(s) and trading activities in the other users' portfolios;
i) Allowing a registered user to post messages onto the message boards of his/her portfolios; Also allowing a registered user to post messages onto the message boards of other users' portfolios;
j) Maintaining a view history list for each account, to allow a registered user to bookmark and to keep track on the portfolios he/she has viewed.

2. The method of claim 1 wherein the financial products can be stock, option, future, currency, or any other financial products that are traded in financial markets;

3. The method of claim 1 wherein a registered user can create one or multiple portfolios in his/her account. The user can also remove portfolio(s) from his/her account; A portfolio list is maintained to show the account owner all the portfolios he/she created in his/her account.

4. The method of claim 1 wherein a registered user can record one or more transactions or trading activities into each of his/her portfolios. A trading activity list is maintained to list all the transactions and trading activities that the user has recorded into the portfolio. Also a portfolio holding list is maintained to list all the financial products holding in the portfolio. Once a transaction or a trading activity is recorded, the financial product involved in the transaction or trading is also recorded into the holding list of the portfolio. The financial product's symbol, trading size, price, and other information are recorded;

5. The method of claim 1 wherein a message board is maintained for each of the portfolios to allow the portfolio owner and other registered user to post messages and to exchange trading ideas;

6. The method of claim 1 wherein a leader boards is provided to list all the portfolios ordered by view count; Also another leader boards is provided to list all the portfolios ordered by last updated date and time;

7. The method of claim 1 wherein a registered user can search portfolio by portfolio name, by portfolio number, or by portfolio owner's name;

8. The method of claim 1 wherein a registered user can access other users' portfolios either through the leader boards as mentioned in claim 6, or through performing searching as mentioned in claim 7, on the system;

9. The method of claim 1 wherein, once a registered user accesses other user's portfolio, he/she can view the portfolio holdings, transactions and trading activities;

10. The method of claim 1 wherein, once a registered user accesses other user's portfolio, he/she can view the message board of the portfolio. The user can also post message onto the message board of the portfolio;

11. The method of claim 1 wherein a registered user is provided a view history list to list all the portfolios, owned by other users, that he/she has viewed. Once a user accesses a portfolio owned by the other user, a feature is provided to allow to user to add the portfolio to his/her view history list. The user can also remove a portfolio from his/her view history list.

12. The view history list of claim 11 wherein, every time the view history list is displayed or refreshed to the user, calculations are executed to checked if any of the portfolios in the list has been updated by the portfolio owner since last time the portfolio was viewed by this user. If any of the portfolios has been updated by the portfolio owner, a notification will be displayed on the view history list to indicate the portfolio was updated.
